(19) United States
(12) Patent Application Publication
(10) Pub. No.: US 2022/0390147 A1
(43) Pub. Date: Dec. 8, 2022

(54) High Performance Photothermal Conversion Materials, Membrane, Layer Structure and Applications Thereof

(71) Applicant: National Taiwan University of Science and Technology, Taipei (TW)

(72) Inventors: Chang-Mou Wu, Taipei (TW); Saba Naseem, Taipei (TW); Tessema Aster Aberra, Taipei (TW)

(21) Appl. No.: 17/468,865

(22) Filed: Sep. 8, 2021

(30) Foreign Application Priority Data
Jun. 3, 2021 (TW) 110120175

(51) Int. Cl. F24S 70/20; F24S 70/14; F24S 70/25; C02F 1/14; C02F 1/32; C02F 1/72; C02F 1/28

(52) U.S. Cl. CPC F24S 70/20; F24S 70/14; F24S 70/25; C02F 1/14; C02F 1/32; C02F 1/725; C02F 1/281; C02F 2305/10; C02F 2101/20

(57) ABSTRACT

Present invention is related to a high performance photothermal conversion materials, membrane, layer structure and applications thereof. The said materials comprise an UV and infrared absorbed material and a visible light absorbed material with at least one of or both of these materials has photothermal conversion ability. These materials could be further produced as a porous membrane or foam layer with a plastic material. Further by layered with another hydrophilic fiber layer, a porous layer structure could be obtained by the present invention with high performance photothermal conversion, uni-direction water transportation and photocatalytic abilities. The present invention could absorb a wide range of light source (UV-to-vis-to-NIP) and convert to another energy like heat solving the insufficiency of conventional photothermal conversion material.

### FIELD OF INVENTION

The present invention is related to a photothermal conversion material, especially to a material that absorbs and converts light source into usable heat energy by a broad/full-spectrum light source.

The photothermal conversion material of the present invention is firstly applied to sewage treatment and will be described hereinafter in detail as follows. However, the present invention is not limited to this particular application. Any similar or equivalent changes should be considered in a claimed scope or disclosed by the present invention.

### BACKGROUND OF THE INVENTION

As the science, technology and human civilization developing, energy consumption has enormously increased nowadays in our modern world. Fossil sources, oil, natural gas and coal, etc., are anticipated to be exhausted in near future by the massive exploitation of human beings. To solve such energy crisis, how to develop a sustainable energy becoming an ultimate solution. Therefore, solar energy, which is known as a clean energy with low pollution, easy to retrieve, and sustainable, has drawn the most attention to be an ideal alternative energy source in the future.

In recent years, solar energy source-related industries have grown so rapidly in ways of both device refinedness and technical research trying to have significant improvements and enhancements in solar energy conversion efficiency. The most important point in this field is how to achieve high efficiency of converting solar energy into useable energy sources. Majority of manufacturers are all actively engaged in such study looking for all kinds of solutions to improve the efficiency for light conversion expecting to create products which can successfully showing such expectations and performance. As the hushing competition among the industry and to deal with such difficulties of the low energy conversion efficiency, it takes longer time for manufacturers to obtain balanced profit to cover the cost and also limit the speed of technology development.

On the other hand, water resources on our plaint are also facing a crisis of depletion, and environmental pollution caused by climate change and population growth has greatly impact and worsen the situation. Instead of promoting the idea of saving water, how to purify sewage water is also one of the solutions to ease the shortage of water resources. Solar energy conversion technology will be a perfect combination of renewable green energy and a solution of water shortage. But how to successfully and efficiently obtain high efficient solar energy conversion is a major problem that needs to be solved. It is eager to have a solution that will overcome or substantially ameliorate at least one or more of the deficiencies of a prior art, or to at least provide an alternative solution to the problems. It is to be understood that, if any prior art information is referred to herein, such reference does not constitute an admission that the information forms part of the common general knowledge in the art

### SUMMARY OF THE INVENTION

In order to solve the problems of the current problems of water resources storage and poor conversion efficiency of solar energy sources, the present invention provides a photothermal conversion material that can efficiently convert full-spectrum light into electrical energy, which can be applied to various fields of seawater desalination and salt production, oil field, sewage and dye desalination.

In accordance, a first aspect of the present invention provides a photothermal conversion material comprising: a composite selected from the following two groups: an ultraviolet light and infrared light absorbing material is selected from the group consisting of tungsten oxide, titanium oxide, copper sulfide or carbon-containing material; and a visible light absorbing material is selected from the group consisting of Iron oxide, Carbon nitride, or precious metals.

In accordance, a second aspect of the present invention provides a photothermal conversion material complex comprising: a thermal conversion material as a membrane as aforementioned being laminated onto a hydrophilic fibrous layer.

In accordance, a third aspect of the present invention provides multiple uses for the photothermal conversion material complex as applied to sewage treatment or seawater desalination.

In accordance, the present invention has the following advantages:

1. The present invention has proved by variety of tests that the water evaporation rate of the present invention is many times higher than that of the conventional photoelectric conversion technology, and with only one-third of the original sewage treatment time is required for the present invention. The production efficiency of seawater desalination and salt production has been greatly improved by the present invention, and the sewage treatment test has proved the present invention be able to convert heavy metal hexavalent chromium into non-harm trivalent chromium.

2. The raw material of the present invention is in low-price and easy to obtain which allows the present invention to be introduced into a manufacturing. Further, the present invention is able to be used in the field of sewage treatment, seawater desalination or salt production to improve the renewable green solar energy conversion efficiency providing a more promising solution for water recycling and reuse.

3. The present invention has the ability to absorb the photon energy of the full-spectrum (UV-to-vis-to-NIP) wavelength, and can efficiently convert light energy directly into heat energy under exposure to any light source.

Many of the attendant features and advantages of the present invention will become better understood with reference to the following detailed description considered in connection with the accompanying figures and drawings.

### BRIEF DESCRIPTION OF THE DRAWINGS

The steps and the technical means adopted by the present invention achieve the above and other objects can be best understood by referring to the following detailed description of the preferred embodiments and the accompanying drawings.

FIG. 1A is an illustration of a photothermal conversion material in accordance with the present invention.

FIG. 1B is a closed-up view of FIG. 1A regarding the fiber composed of the photothermal conversion material in accordance with the present invention.

FIG. 2 is a SEM figure illustrating porous fiber composed of the photothermal conversion material in accordance with the present invention.

FIG. 3 is an illustration of usage for the photothermal conversion material in accordance with the present invention.

FIG. 4 is an illustration of hydrophilic and hydrophobic gradients structure of the photothermal conversion material complex in accordance with the present invention.

### DETAILED DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts. It is not intended to limit the method by the exemplary embodiments described herein. In the following detailed description, for purposes of explanation, numerous specific details are set forth in order to attain a thorough understanding of the disclosed embodiments. It will be apparent, however, that one or more embodiments may be practiced without these specific details. As used in the description herein and throughout the claims that follow, the meaning of “a”, “an”, and “the” may include reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to.

The present invention first provides a full-spectrum high performance photothermal conversion material comprising an ultraviolet light and infrared light absorbing material, and a visible light absorbing material, the ultraviolet light and infrared light absorbing material and/or the visible light absorbing material has an ability of absorbing a light source and converting it into another kind of energy, such as thermal energy.

The ultraviolet light and infrared light absorbing material in the present invention comprises tungsten oxide, titanium oxide (TiO), copper sulfide (CuS) or carbon-containing material. The visible light absorbing material includes Iron oxide, Carbon nitride, or precious metals such as gold or silver. The carbon-containing material comprises graphite, graphene or carbon tube, or other likely materials.

The aforementioned Titanium oxide (TiO), Copper sulfide (CuS) or carbon-containing materials in the present invention may already have the ability to absorb a light source in full-spectrum, and can be combined with other single light source absorbing materials to form a composite material achieving a more comprehensive full spectrum absorption efficiency.

The preferred embodiment of the present invention includes the ultraviolet light and infrared light absorbing material with the content in mole ratios ranging from 1:2 to 5:1, such as tungsten oxide (tungsten oxide (WOₓ) or tungsten bronze (MₓWO₃), where x may be 0.01-100), and the visible light absorbing material, such as a composite material obtained from one or more of following two components: iron oxide (Fe₃O₄) or carbon nitride (g-C3N4). The tungsten oxide includes tungsten trioxide Wo₃ or WO_{2.72}. The tungsten bronze includes rubidium tungsten bronze (RbₓWO₃, where x may be 0.01-100) or cesium tungsten bronze (CsₓWO₃, Cs_{0.32}WO₃, where x may be 0.01˜100). The photothermal conversion material of the present invention can have a variety of structural types, including nanoparticles, nanorods, nanowires, nanobundles, and nanocrystals or Urchin-like spheres.

The photothermal conversion material in the present invention has the ability to absorb the photon energy from the full-spectrum (UV-to-vis-to-NIP) wavelength, and can efficiently convert light energy directly into heat energy under light illumination. On the other hand, the tungsten compound in the present invention contains tungsten oxide (WOₓ) or tungsten bronze (MₓWO₃) components, which have ultraviolet light, infrared light and enhanced near-infrared absorption capabilities. The tungsten bronze is MₓWOₓ produced by doping metal elements in tungsten oxide to enhance the light absorption in the solar spectrum, or strong local surface plasmon resonance (LSPR) and interval charge transfer (oxidation from W6⁺ to W5⁺ state). By mixing this type of tungsten material with other materials, a full-spectrum photocatalyst with advanced light absorption efficiency are formed.

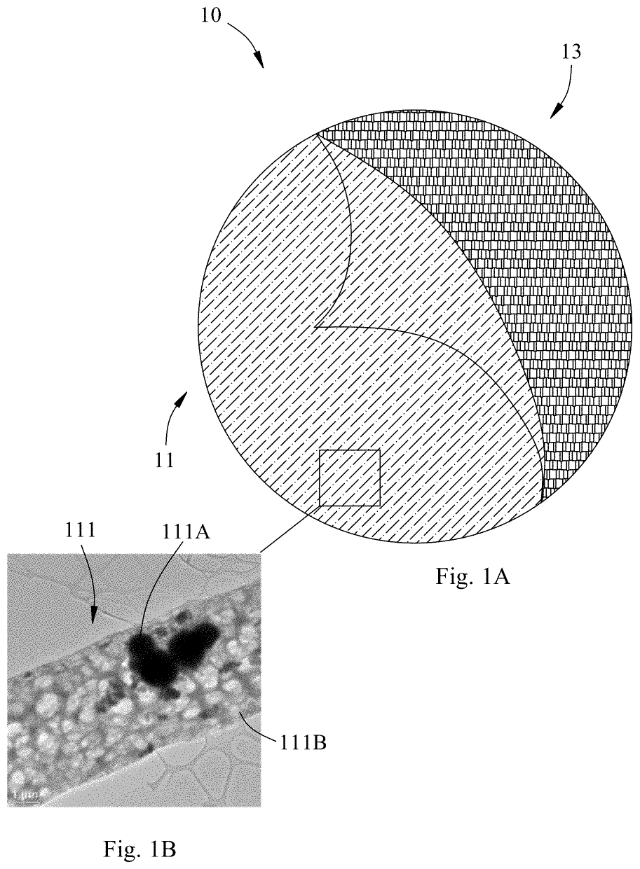

With reference to FIGS. 1A and 1B, the aforementioned photothermal conversion material 111A and a suitable plastic material 111B are formed as an electrospinning, solution with a concentration ranging from 1 wt % to 20 wt %, more preferably between 3 wt % to 10 wt %. An electrospinning process is utilized to form a composite electrospun fiber 111 to form a composite electrospun fiber layer 11. Further the composite electrospun fiber layer 11 is laminated on a hydrophilic fibrous layer 13 formed from a hydrophilic fiber 131 to form a photothermal conversion composite layer structure 10.

The plastic material 111B preferably contains polyvinylidene fluoride (PVDF) or triacetate cellulose (TAC), more preferably the TAC could be recycled triacetate cellulose (r-TAC) and the like. The photothermal conversion material 111A and the plastic material 111B are mixed to form an electrospinning liquid using electrospinning technology to produce the composite electrospun fiber layer 11 on the hydrophilic fibrous layer 13. The hydrophilic fibrous layer 13 is preferably to be polyvinyl alcohol (PVA), modified hydrophilic polyester or polyurethane (PU). The modified hydrophilic polyester comprises a non-woven fabric of ethylene terephthalate (PET) fiber.

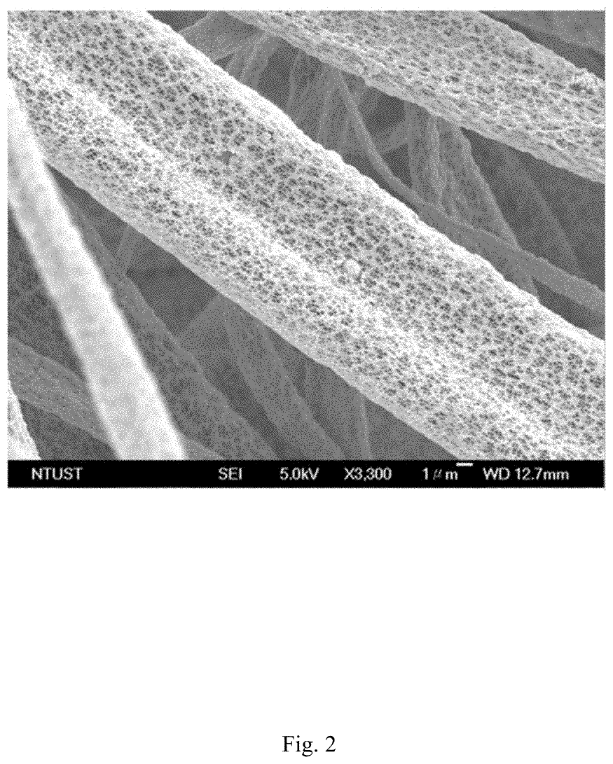

On the other hand, the photothermal conversion material 111A and the plastic material 111B are electrospun to produce the composite electrospun fiber layer 11. The composite electrospun fiber layer 111 is preferably to have its fiber with porous structure as shown in FIG. 2. The plastic material 111B is used as a polymer matrix providing the composite electrospun fiber layer 11 hydrophobic and moisture-permeable abilities.

It is worth noticed that the composite electrospun fiber layer 111 as mentioned above is only a preferred embodiment of the present invention. However, the photothermal conversion material 111A and a compatible plastic 111B could also be used by other processes such as melt-blown technique to form a porous fiber membrane layer, or a foaming process to form a porous foamed membrane layer and further laminated on the hydrophilic fibrous layer 13 to form the photothermal conversion composite layer structure 10 as described by the present invention.

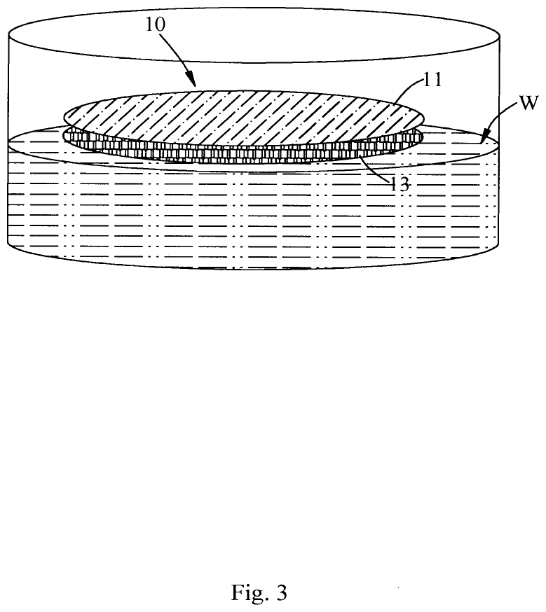

With reference to FIG. 3, the photothermal conversion layer structure 10 of the present invention is preferably used for the function of driving water evaporation by the hydrophilic fibrous layer 13 contacting with any treating liquid surface W. As such, the hydrophilic fibrous layer 13 will continue to absorb moisture into the fiber from the treating liquid surface, and the photothermal conversion composite layer structure 10 on the upper layer to directly absorb light sources from an external environment, such as solar energy to convert light energy into heat. By using that generated heat, the moisture can gradually evaporate from the treating liquid surface W. The photothermal conversion composite layer structure 10 accelerates the effect of moisture evaporation. Because the photothermal conversion composite layer structure 10 provided by the present invention is a combination of hydrophilic and hydrophobic layers, the hydrophilic layer contacting the treating liquid surface W to allow the liquid being unidirectionally moved to the hydrophobic layer and eventually dispersed or evaporated.

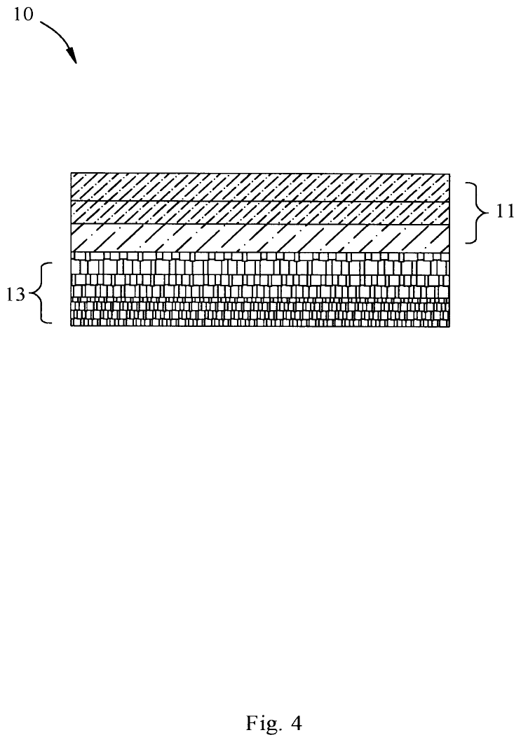

More preferably, the unidirectional moisture conductivity of the photothermal conversion composite layer structure 10 can be further achieved through the hydrophilic and hydrophobic gradients between structures in each layer. With reference to FIG. 4, by using multiple layers of the hydrophobic layer 13 (for example three layers as shown in FIG. 4) with its composed hydrophobic fiber with different contact angle/materials to have the so-called hydrophobic gradient. The composite electrospun fiber layer 11 can also have similar design with multiple layers (for example three layers as shown in FIG. 4) with different degree of hydrophilic ability achieving from different porosity. The hydrophilic and hydrophobic gradient effect would allow the present invention to have a better unidirectional moisture conductivity.

The structural engineering strategies of the photothermal conversion composite layer structure 10 provided by the present invention comprises but not limited to: light absorption and light conversion engineering, thermal localization and thermal conductivity, waterway design, interface engineering, bionic structure design, 3D evaporator design and salt discharge structure design, etc. The present invention has a broad band or full-spectrum light absorption ability and high efficiency photothermal conversion ability, and has good heat insulation and high efficiency water transmission efficiency.

### EMBODIMENT 1

### Synthesis of RbₓWO₃—Fe₃O₄ Nanocomposite

0.5952 g of WCl₆ was continuously stirred for 15 minutes and dissolved in absolute ethanol, and then 0.076 g of RbOH was added. Then add 24 mL of acetic acid to the mixed solution at 240° C. and put it in an sterilizer lined with Teflon lining for 20 hours. The solution was taken out of from the sterilizer, centrifuged and dried in an oven at 60° C. to obtain RbₓWO₃.

Next, 0.2 g of the above-mentioned RbₓWO₃ was dispersed and dissolved in 20 mL of absolute ethanol using ultrasonic and stirred for 1 hour. In the suspension, add 0.5 mol (mole) of Fe₃O₄ nanoparticle in ethanol solution 20 mL and stir quickly. The suspension was then centrifuged and dried in an oven at 60° C. for 1 hour.

Preparation of RbₓWO₃—Fe₃O₄ Nanocomposite Electrospun Fiber Membrane and Photothermal Conversion Composite Layer Structure

The aforementioned RbₓWO₃—Fe₃O₄ nanocomposite was stirred at a ratio of 9:1 (v/v) and completely dissolved in 5 wt % rTAC to form an electrospinning solution. The electrospinning solution was further applied to electrospinning process at a voltage of 15 kV, a flow rate of 0.5 ml/h, and a distance between needle tip and collector is 15 cm, and the RbₓWO₃—Fe₃O₄ nanocomposite and rTAC as plastic material are spun on the PET non-woven fabric to obtain the photothermal conversion composite layer structure of the present invention.

### EMBODIMENT 2

Synthesis of WO_{2.72}—Fe₃O₄ Nanocomposite

Dissolve 0.7 g of WCl₆ in 70 mL of absolute ethanol and continuous stirring for 15 minutes to obtain a yellow solution. At the same time, take another container to add 0.231 g of Fe₃O₄ powder to 50 mL of absolute ethanol and stir with ultrasonic to obtain a black solution.

The yellow solution and the black solution were mixed and placed in a sterilizer with a Teflon lining and heated in an oven at 180° C. for 24 hours. The suspension was then centrifuged and dried in an oven at 60° C. for 8 hours.

Preparation of WO_{2.72}—Fe₃O₄ Nanocomposite Electrospun Fiber Membrane and Photothermal Conversion Composite Layer Structure

The aforementioned WO_{2.72}—Fe₃O₄ was stirred at a ratio of 250 g and completely dissolved in 5 wt % rTAC to form an electrospinning solution. The electrospinning solution is applied to the electrospinning process at a voltage of 15 kV a relative humidity of 50%, a flow rate of 0.5 ml/h, and a distance between needle tip and collector is 15 cm. WO_{2.72}—Fe₃O₄ nanocomposite and rTAC as being plastic material are spun on the PVA non-woven fabric to obtain the photothermal conversion composite layer structure 10.

### EMBODIMENT 3

Synthesis of Cs_{0.32}-gC₃N₄ Nanocomplex

gC₃N₄ was dissolved in 40 mL of ethanol and stirred for 1 hour. Next, add 0.297 g of WCl6 and vigorous stirring and mixing well.

Add 0.065 g of CSOH·H2) to the above suspension and stir for 7 minutes. Further, 10 mL of acetic acid was added, and the suspension was placed in a sterilizer lined with Teflon and heated in an oven at 240° C. for 20 hours for reaction. After the reaction was completed, it was cooled to room temperature, and the resulting product was washed with ethanol 4 times, and then dried at 60° C. for 8 hours to obtain a Cs0.32-gC₃N₄ nanocomposite.

Preparation of the Cs_{0.32}-gC₃N₄ Nanocomposite Electrospun Fiber Membrane and Photothermal Conversion Composite Layer Structure

The aforementioned. Cs0.32-gC₃N₄ nanocomposite was mixed in a dimethylformamide solution (Dimethylformamide, DMF) with ultrasonic for 1 hour, then 2.2 g of PVDF particles were added and heated and stirred at 120° C. for 2 hours and obtain an electrospinning solution after cooling. Then, the electrospinning liquid is electrospun on the PVA non-woven fabric to obtain the photothermal conversion composite layer structure 10.

<Validation Tests>

First, a UV-VIS-NIR spectrometer is used to perform a full-spectrum light energy absorption test to above three embodiments provided by the present invention as shown in Chart 1 below.

CHART 1
full spectrum light absorption ability

| | Type of light source | | |
|---|---|---|---|
| Embodiment | UV light | Visible light | Near infrared light |
| Embodiment 1 | Absorbed | Absorbed | Absorbed |
| Embodiment 2 | Absorbed | Absorbed | Absorbed |
| Embodiment 3 | Absorbed | Absorbed | Absorbed |

Next, several thermal properties tests are performed to prove that the present invention has the ability to generate heat for evaporating moisture. The results are shown as Chart 2 below.

CHART 2
Thermal properties

| | Thermal abilities | | | |
|---|---|---|---|---|
| | Thermal | Thermal | Thermal | Thermal |
| | conductivity | diffusivity | absorption | resistance |
| Embodiment | (mW/m · K) | (mm²/s) | (Ws^{1/2}/m₂K) | (m²mK/W) |
| Embodiment 1 | 28.10 | 0.13 | 78.17 | 21.20 |
| Embodiment 2 | At least | At least | At least | At least |
| | 27.00 | 0.13 | 78.17 | 21.20 |
| Embodiment 3 | 27.00 | At least | At least | At least |
| | | 0.13 | 78.17 | 21.20 |
| Comparation | 25.60 | 0.30 | 49.20 | 22.60 |
| embodiment | | | | |
| (Pure rTAC | | | | |
| film) | | | | |

The present invention also performs several tests for validating the conversion efficiency of light energy conversion and moisture evaporation with the photothermal conversion composite layer structure 10 at the treating liquid surface W as shown in Chart 3 below. By laying the preferred embodiments of the present invention on the surface of the treating liquid surface, the results show that the present invention has a strong interface heating ability, and a hot zone is obviously generated at the air-water interface under the light source, and the temperature of the water interface increases with treatment time of the light source. Under such thermal environment, the present invention successfully generates heat letting the water surface evaporated by the unidirectional layered structure. The present invention also has the excellent light-to-heat conversion efficiency under solar radiation and has stable performance and durability during multiple cycles showing that the present invention has the potential to be successfully introduced into the market.

CHART 3
Photothermal conversion efficiency

| | Conversion | | | | |
|---|---|---|---|---|---|
| | Moisture weight loss | | Light | Comparison of | |
| | after 35 minutes of | Evaporation | conversion | light source types | |
| | exposure to light source | rate/hour | efficiency | for photothermal | Number of |
| Embodiment | (kg/m²) | (kg/m²h) | (%) | effect | cycles |
| Embodiment 1 | 1.3 | 3.56 | 89.3 | Solar energy > | 15 |
| | | | | NIR > Visible | |
| | | | | light | |
| Embodiment 2 | At least | At least | At least | Solar energy > | 15 |
| | 1.3 | 3.56 | 89.3 | NIR > Visible | |
| | | | | light | |
| Embodiment 3 | 1.5 | 2.70 | 95.3 | Solar energy > | 12 |
| | | | | NIR > Visible | |
| | | | | light | |
| Comparation embodiment [symbol] , | 0.60 | 1.44 | — | — | — |
| [symbol] [symbol] Water | | | | | |
| surface without applying any | | | | | |
| light-to-heat conversion | | | | | |
| structure | | | | | |

The present invention has the ability of photothermal conversion with unidirectional structure which is particularly suitable for applications in seawater desalination or desalination. By using the preferred embodiments provided by the present invention, the salt ion content in sea water and the collected condensate water before and after the treatment are shown in Table 4. The present invention has the ability to treat sea water into drinking water (according to the definition of the salt ion content in drinking water by the World Health Organization) proving that the present invention does have excellent desalination ability.

CHART 4

Treatment status

| | Before treatment | After treatment |
|---|---|---|
| Content of the irons | (seawater) | (drinking water) |
| Na⁺ | 27500 ppm | 3.23 ppm |
| K⁺ | 1000 ppm | 2.4 ppm |
| Mg²⁺ | 5300 ppm | 0.17 ppm |
| Ca²⁺ | 1200 ppm | 2.38 ppm |

On the other hand, the photothermal conversion composite layer structure 10 provided by the present invention also has the ability to photocatalytically decompose heavy metal components. For example, the treated water also contains the pollutants like nitrophenol, tetracycline (tetracycline), methylene blue/orange (methylene blue/orange, MB/MB) and rhodamine B (rhodamine B) or these pollutants combination. The purified condensate water is tested to be colorless and transparent, and the pollutant content in the tested water is almost in zero content. The porous fiber structure of the present invention has the function of adsorbing pollutants, and the photothermal conversion material has the ability to convert organic pollutants, such as but not limited to hexavalent chromium (Cr(VI)) into non-toxic trivalent chromium (Cr(III)) and maintained in the porous membrane without returning to the water achieving the effect of sewage purification.

The foregoing descriptions are only preferred embodiments of the present invention, and are not intended to limit the scope of rights claimed by the present invention. All other equivalent changes or modifications completed without departing from the spirit disclosed by the present invention shall include Within the scope of the patent application of the present invention.

What is claimed is:

1. A photothermal conversion material comprising: a composite selected from the following two groups:
an ultraviolet light and infrared light absorbing material is selected from the group consisting of tungsten oxide, titanium oxide, copper sulfide or carbon-containing material; and
a visible light absorbing material is selected from the group consisting of Iron oxide, Carbon nitride, or precious metals.

2. The photothermal conversion material as claimed in claim 1, wherein:
the tungsten oxide further comprises tungsten bronze;
the carbon-containing material comprises graphite, graphene or carbon tube; and
the precious metals comprises gold or silver.

3. The photothermal conversion material as claimed in claim 2, wherein:
the tungsten bronze comprises rubidium tungsten bronze or cesium tungsten bronze.

4. The photothermal conversion material as claimed in claim 1, wherein:
the photothermal conversion material has photocatalystic ability.

5. The photothermal conversion material as claimed in claim 2, wherein:
the photothermal conversion material has photocatalystic ability.

6. The photothermal conversion material as claimed in claim 1, wherein the photothermal conversion material is in a form of porous fibrous membrane or porous foamed membrane by a plastic material.

7. The photothermal conversion material as claimed in claim 2, wherein the photothermal conversion material is in a form of porous fibrous membrane or porous foamed membrane by a plastic material.

8. The photothermal conversion material as claimed in claim 3, wherein the photothermal conversion material is in a form of porous fibrous membrane or porous foamed membrane by a plastic material.

9. The photothermal conversion material as claimed in claim 4, wherein the photothermal conversion material is in a form of porous fibrous membrane or porous foamed membrane by a plastic material.

10. The photothermal conversion material as claimed in claim 6, wherein the plastic material comprises polyvinylidene fluoride or triacetate cellulose.

11. The photothermal conversion material as claimed in claim 7, wherein the plastic material comprises polyvinylidene fluoride or triacetate cellulose.

12. The photothermal conversion material as claimed in claim 8, wherein the plastic material comprises polyvinylidene fluoride or triacetate cellulose.

13. The photothermal conversion material as claimed in claim 9, wherein the plastic material comprises polyvinylidene fluoride or triacetate cellulose.

14. A photothermal conversion material complex comprising: a thermal conversion material as a membrane as claimed in claim 1 being laminated onto a hydrophilic fibrous layer.

15. The photothermal conversion material complex as claimed in claim 14, wherein the hydrophilic fibrous layer comprises polyvinyl alcohol, polyester or polyurethane.

16. The photothermal conversion material complex as claimed in claim 14, wherein the thermal conversion membrane and/or the hydrophilic fibrous layer has gradients of porous or contact angle from the material to have gradient hydrophilic and hydrophobic structure.

17. The photothermal conversion material complex as claimed in claim 15, wherein the thermal conversion membrane and/or the hydrophilic fibrous layer has gradients of porous or contact angle from the material to have gradient hydrophilic and hydrophobic structure.

18. The photothermal conversion material complex as claimed in claim 14, wherein the complex is applied to sewage treatment or seawater desalination.

19. The photothermal conversion material complex as claimed in claim 15, wherein the complex is applied to sewage treatment or seawater desalination.
